(19) United States
(12) Patent Application Publication
(10) Pub. No.: US 2024/0142099 A1
(43) Pub. Date: May 2, 2024

(54) FLOATING MULTI-DIRECTIONAL LIGHT APPARATUS

(71) Applicant: Jose Longoria, Miami, FL (US)

(72) Inventor: Jose Longoria, Miami, FL (US)

(21) Appl. No.: 18/501,018

(22) Filed: Nov. 2, 2023

Related U.S. Application Data
(60) Provisional application No. 63/421,733, filed on Nov. 2, 2022.

(51) Int. Cl. F21V 31/00; F21S 9/03; F21V 5/00; F21V 7/00

(52) U.S. Cl. CPC F21V 31/005; F21S 9/037; F21V 5/00; F21V 7/00

(57) ABSTRACT

We disclose and discuss here a device that is a floating lamp that projects light beams decorating all desired surfaces of a pool, including but not limited to, the pool floor, the pool edge, and above the pool. It uses an arrangement of mirrors, or other reflective surfaces, as well as, lenses to maximize the number and direction of projected light beams and to avoid a cast shadow caused by a ballast.

### CROSS-REFERENCE TO RELATED APPLICATIONS

The present application is a non-provisional patent application claiming the benefit of priority to previously-filed U.S. Provisional Patent Application No. 63/421,733, filed on Nov. 2, 2022, which is currently pending and incorporated by reference, in its entirety, as if fully set forth herein.

### FIELD OF THE INVENTION

The present invention generally relates to lighting apparatus, and more specifically to, a floating multi-directional lighting apparatus.

### BACKGROUND OF THE INVENTION

Floating lights are popular items used to decorate pools and spas. Some are designed to project light patterns onto the pool bottom. It is known in the art for these lamps have battery operated LED bulbs combined with lenses contained in a sealed, floating assembly. See FIG. 1. In the current state of the art, however, the light bulbs are normally mounted on the upper part of the top housing with the bulbs pointing down. The bottom housing is typically a clear dome covered with in-molded lenses. A weight is located in the lowest part as a ballast for floating right side up keeping the light pointed down. In the current state of the art, a focal distance of about 3 inches between the bulb and the lenses is needed to allow the light from the bulb focus into a beam. That way dots of color will be focused and visible projected on the pool bottom. The physical requirements for the optic arrangement create a bulky object inconvenient for shipping. The large air bubble known in the art, has lighting components mounted near the top, requiring a ballast at the bottom to keep the lights pointing downwards. That weight mass tends to block the light creating a shadow on the pool floor. Because the light source in the current art points down, the side walls of the pool usually do not receive much, if any, light. Because of the limitations in the current state of the art, there is no opportunity to illuminate the lamp itself or to project lights upwards to light the surroundings, or direct beams of light where desired.

Therefore, there is a need in the art for an improvement in the art of floating pool lights that can direct beams of light where desired and in a smaller package. There is also a need in the art for a floating pool light that can direct light such as to minimize or eliminate shadows from a ballast. There is a further need in the art for a floating pool light that, in addition to projecting beams of light down onto the pool floor, also can direct beams of light substantially along the surface of the water to illuminate the coping or pool edge.

### SUMMARY OF THE INVENTION

We disclose and discuss here a device that is a floating lamp that projects light beams decorating all desired surfaces of a pool, including but not limited to, the pool floor, the pool edge, and above the pool. See FIGS. 2a-2c. It uses an arrangement of mirrors, or other reflective surfaces, as well as, lenses to maximize the number and direction of projected light beams and to avoid a cast shadow caused by a ballast.

As shown in the simplified cross-sectional representation of FIG. 3, the apparatus includes a light engine 1, a dome 2, a reflector 3, and a lid 4. The dome primarily provides a sealable volume V that provides a buoyancy force to the apparatus. The dome preferably also includes one or more lens integral to the dome itself and configured to receive and focus a light beam emitted from the light engine. The light engine includes at least one light source powered by a power supply and may be further enclosed in its own housing. The light engine substantially provides a ballast force to counter the buoyancy force provided by the dome's sealable volume. The lid covers the dome and, together with the dome, creates the sealed volume. The reflector is positioned to receive a one or more beam of light from the light source and direct it reflectively to one or more lens integral to the dome. See FIG. 4.

The components of the apparatus are arranged such that the light engine ballast positions the apparatus at a desired floating height and level relative to the water surface. In preferred embodiments, the balance between the buoyancy force and the ballast force are such that the apparatus floats in the water with the lid just above the surface of the water, and pool side lenses are substantially at the surface of the water, and any pool bottom lenses are substantially below the surface of the water. The light engine is preferably centered with respect to the dome such that the apparatus floats level with respect to the plane coincident with the surface of the water. The light engine may be fixed in a non-removable condition with respect to the dome, in other embodiments, the light engine is selectably removable from the apparatus, substantially external to the dome, or adjustably engageable with the dome.

An object of the present invention is to provide a floating light that is configured to focus beams of light onto pool surfaces below the water line.

Another object of the present invention is to provide a floating pool light that is configured to focus beams of light onto the pool side-walls or coping, substantially horizontally in relation to the water surface.

Yet another object of the present invention is to provide a floating light that is configured to focus beams of light along the surface of the water.

A further object of the present invention is to provide a floating light apparatus that is adapted to be manufactured using a variety of materials and methods, thereby allowing for customization in terms of manufacturing cost, colors, patterns, durability, and ornamental features.

### BRIEF DESCRIPTION OF THE DRAWINGS

In the accompanying figures, like reference numerals refer to identical or functionally similar elements throughout the separate views. The accompanying figures, together with the detailed description below are incorporated in and form part of the specification and serve to further illustrate various embodiments and to explain various principles and advantages all in accordance with the present invention, in which:

FIG. 1 is a simplified cross-sectional view of the Prior Art;

FIGS. 2a, 2b, and 2c are simplified cross-sectional views according to an embodiment of the present invention;

FIG. 3 is a simplified cross-sectional view according to an embodiment of the present invention;

FIG. 4 is a simplified cross sectional view representing light beam propagation through the embodiment of FIG. 3;

FIG. 5 is a top isometric view according to an embodiment of the present invention;

FIG. 6 is a bottom isometric view of the embodiment in FIG. 5;

FIG. 7 is a top view of the embodiment in FIG. 5;

FIG. 8 is a front view of the embodiment in FIG. 5;

FIG. 9 is a right view of the embodiment in FIG. 5, where the left view is similar;

FIG. 10 is a bottom view of the embodiment in FIG. 5;

FIG. 11 is a cross-sectional view of the embodiment in FIG. 5;

FIG. 12 is an exploded view of the embodiment in FIG. 5;

FIG. 13 is an isometric view of a lensed dome according to the embodiment in FIG. 5;

FIG. 14 is an isometric view of a light engine according to the embodiment in FIG. 5;

FIG. 15 is an exploded view of the light engine of FIG. 14;

FIG. 16 is a simplified cross-sectional view according to an embodiment of the present invention;

FIG. 17 is a simplified detail view of the lighting system according to an embodiment of the present invention;

FIG. 18 is a simplified cross-sectional view showing light path and focal length according to the prior art;

FIG. 19 is a simplified cross-sectional view showing light path and focal length according to embodiments of the present invention;

FIG. 20 is a simplified cross-sectional view showing horizontal light path propagation according to embodiments of the present invention;

FIG. 21 is an isometric view of the embodiment shown in FIG. 5 with an optional base attachment;

FIG. 22 is a top isometric view according to another embodiment of the present invention;

FIG. 23 is a bottom isometric view of the embodiment shown in FIG. 22;

FIG. 24 is a cross-sectional view of the embodiment shown in FIG. 22; and

FIG. 25 is an exploded view of the embodiment shown in FIG. 22.

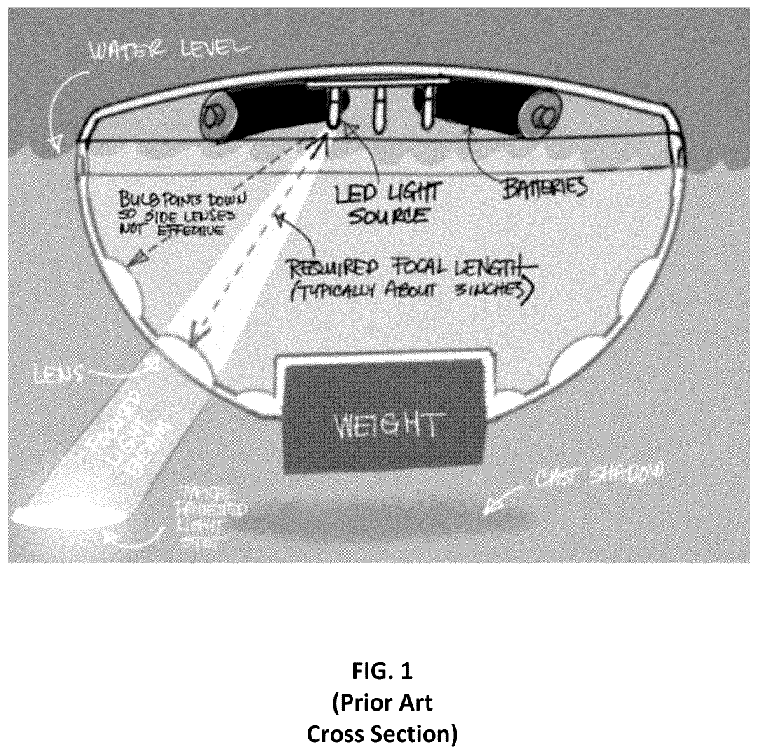

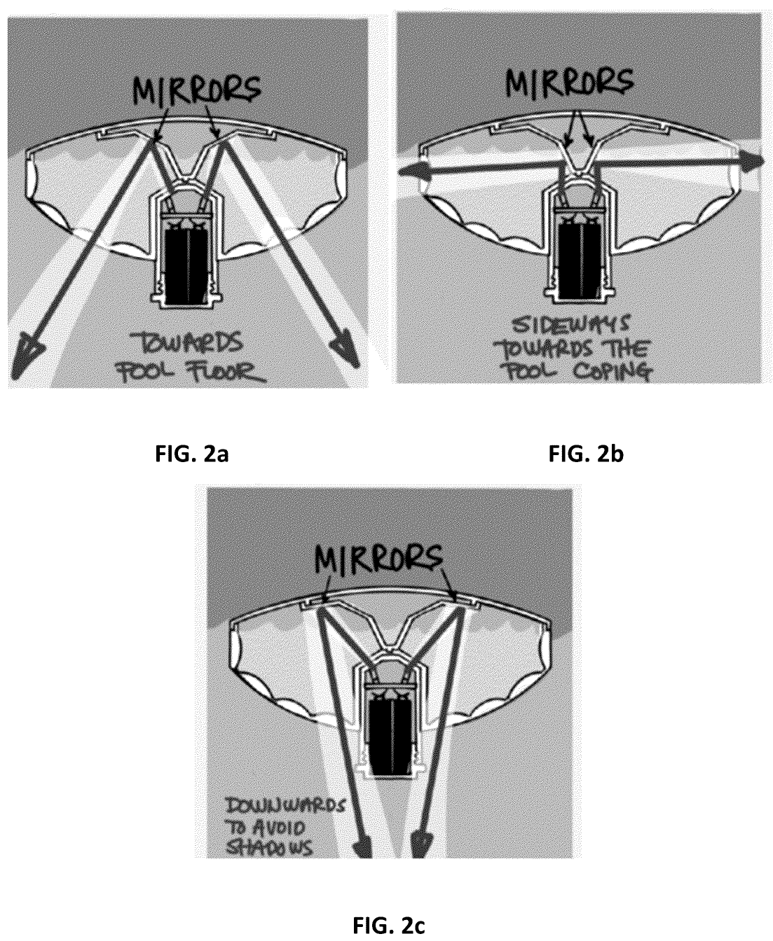

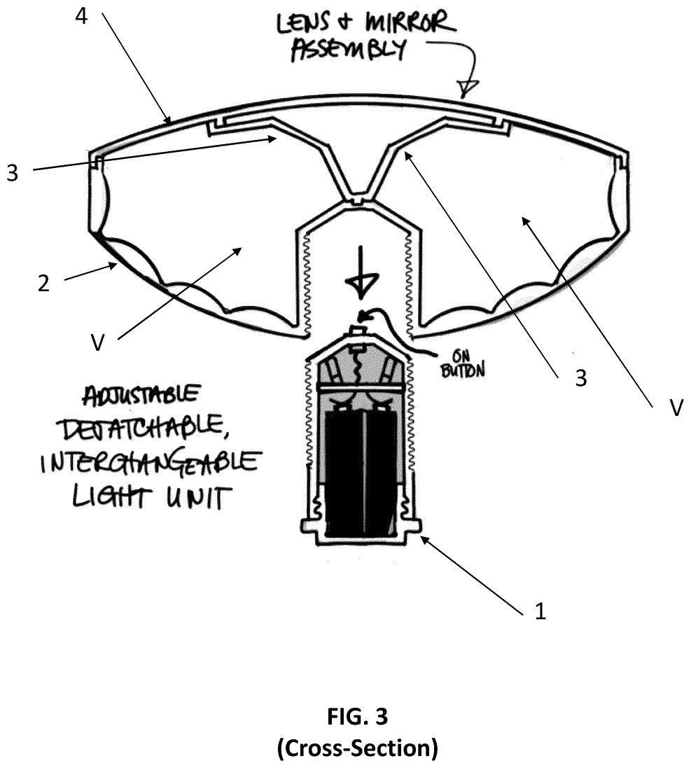

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

Before describing in detail embodiments that are in accordance with the present invention, though an embodiment may be disclosed as including several features, other embodiments of the invention may include fewer than all such features. Thus, for example, a claim may be directed to less than the entire set of features in a disclosed embodiment, and such claim would not include features beyond those features that the claim expressly recites.

The present disclosure is not a literal description of all embodiments of the invention(s). Also, the present disclosure is not a listing of features of the invention(s) which must be present in all embodiments.

### Non-Limiting Definitions

The title of the present application and headings of sections provided in the present application are for convenience only, and are not to be taken as limiting the disclosure in any way.

The following non-limiting definitions are provided as a guide to interpreting the present invention:

The term “product” or “apparatus” means any machine, manufacture, and/or composition of matter, unless expressly specified otherwise.

The term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of each of” the plurality of things.

Numerical terms such as “one”, “two”, etc. . . . when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g., 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

Embodiments of the present invention are disclosed and described herein in the context of an apparatus configured to illuminate and float in a swimming pool. It will be evident to those skilled in the art that the invention should not be limited to a swimming pool, unless such limitation is expressly stated in a claim, and the embodiments of the present invention may be equally adapted for use in a hot tub, bath tub, pond, fountain, or other structure—natural or man-made—where water (or other such similar surrounding fluid) may be contained.

The Apparatus.

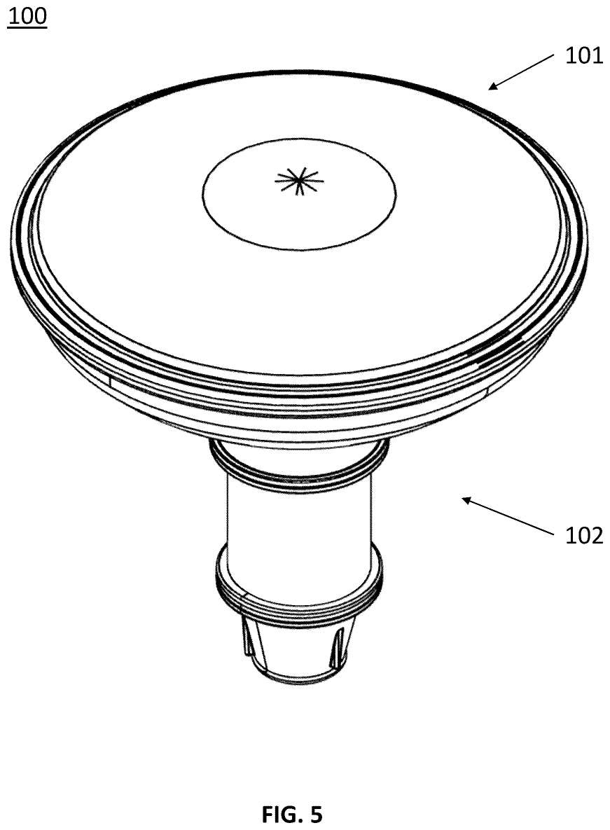

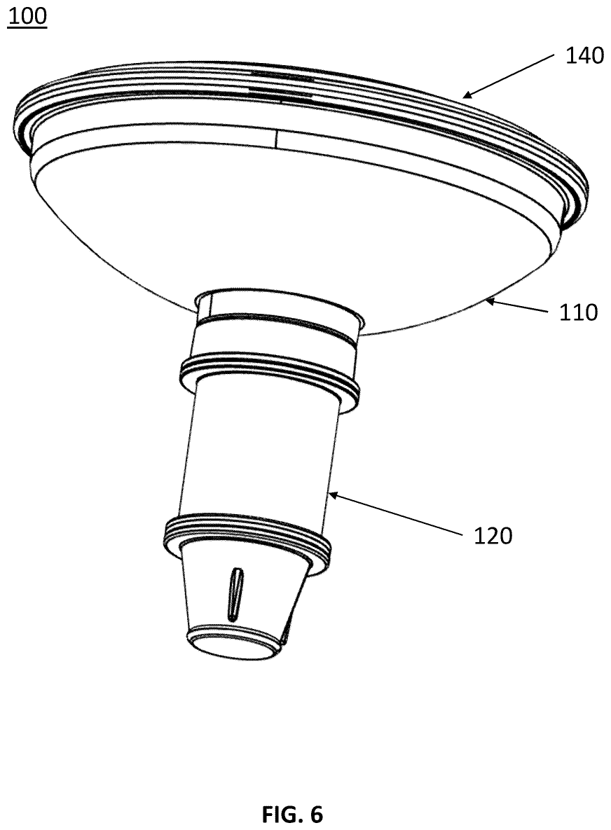

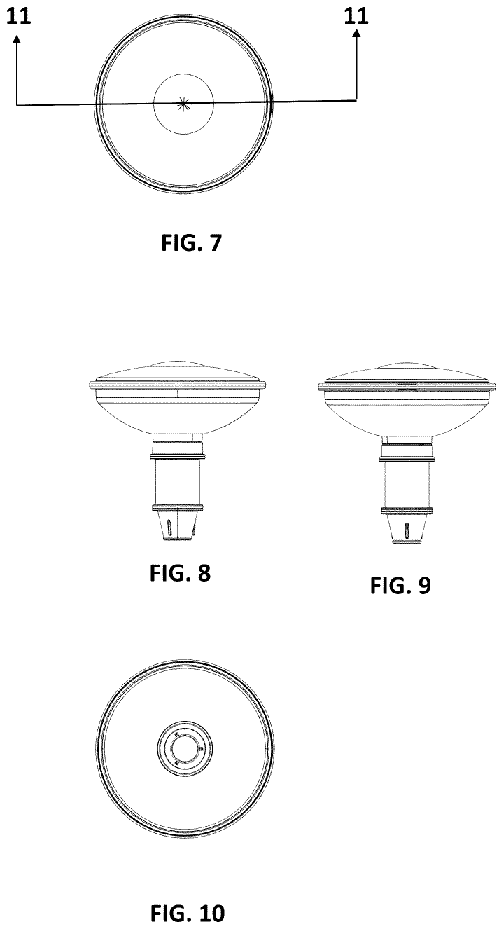

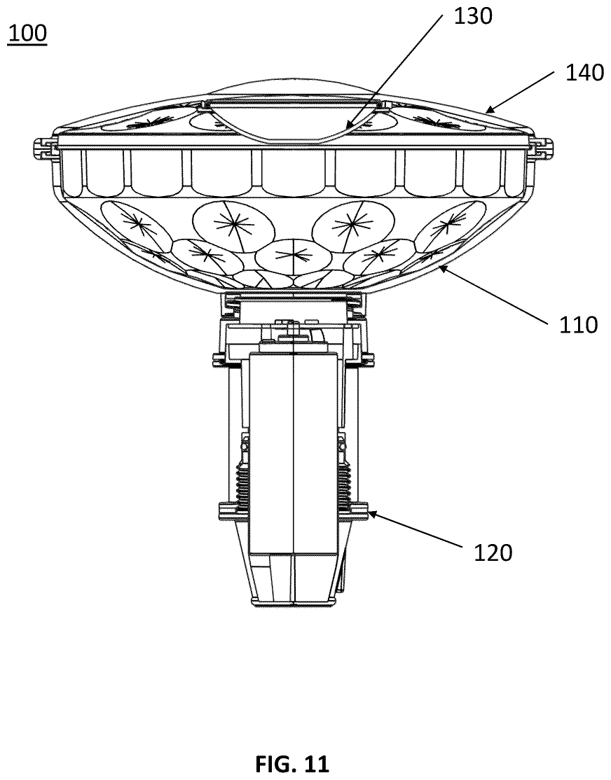

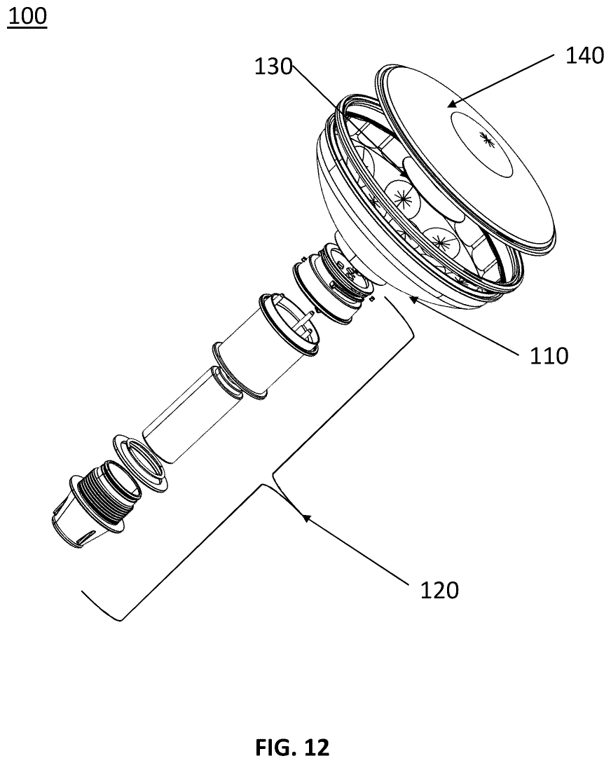

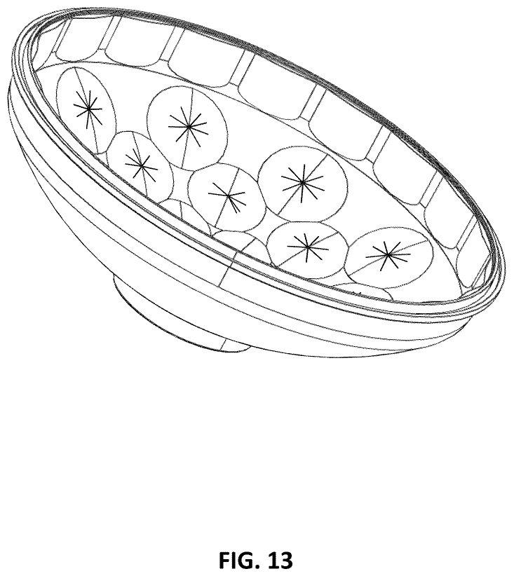

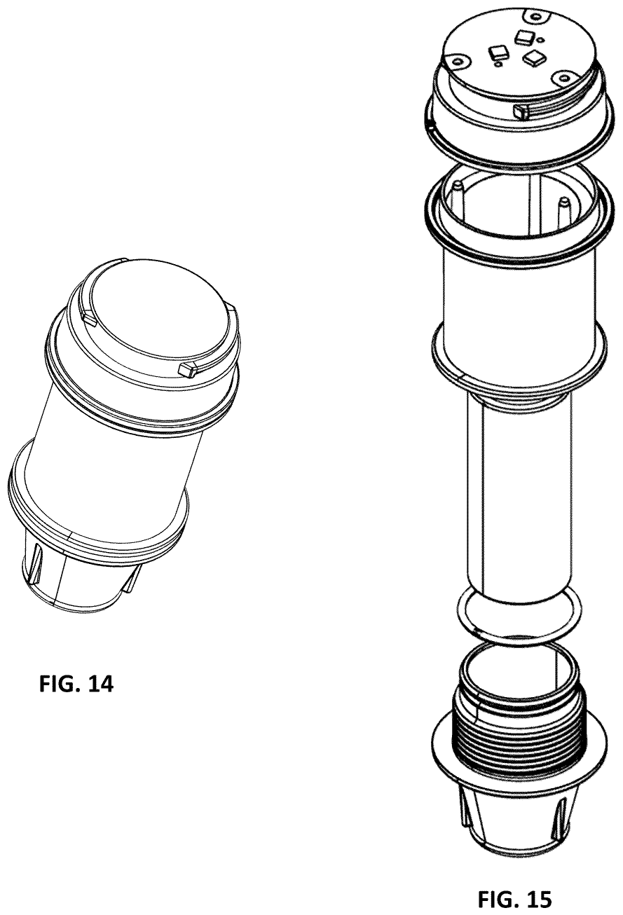

Referring now to the figures, in general, and FIGS. 5-15, in particular, we disclose a preferred embodiment of the invention, namely, a light apparatus 100 that is configured to float buoyantly, in a liquid—for example, in a pool. The light apparatus 100 is further adapted such that a first portion 101 of the light apparatus 100 is above the surface of the liquid, and a second portion 102 of the light apparatus 100 is submerged below the surface of the liquid.

Generally, embodiments of the light apparatus include a dome 110, a light engine 120, a reflector 130, and a lid 140. These components are configured such that the lid 140 and the dome 110 form a sealed volume resistant to water intrusion. One or more reflector 130 are positioned within the sealed assembly of the dome 110 and lid 140. The light engine 120 is configured in relation to the dome 110 and lid 140 to project light onto the one or more reflector 130 and, in embodiments, the light engine may also project light directly onto the dome or lid.

A light apparatus 100, such as is shown in FIGS. 5-15, is configured to float buoyantly in a liquid such that a first portion of the light apparatus is above a surface of the liquid and a second portion of the light apparatus is submerged below the surface of the liquid. The light apparatus comprises: a housing that includes dome 110 and a lid 140; a one or more reflector 130 within the housing; and, a light engine 120 that includes a ballast, a power source, and a one or more light source.

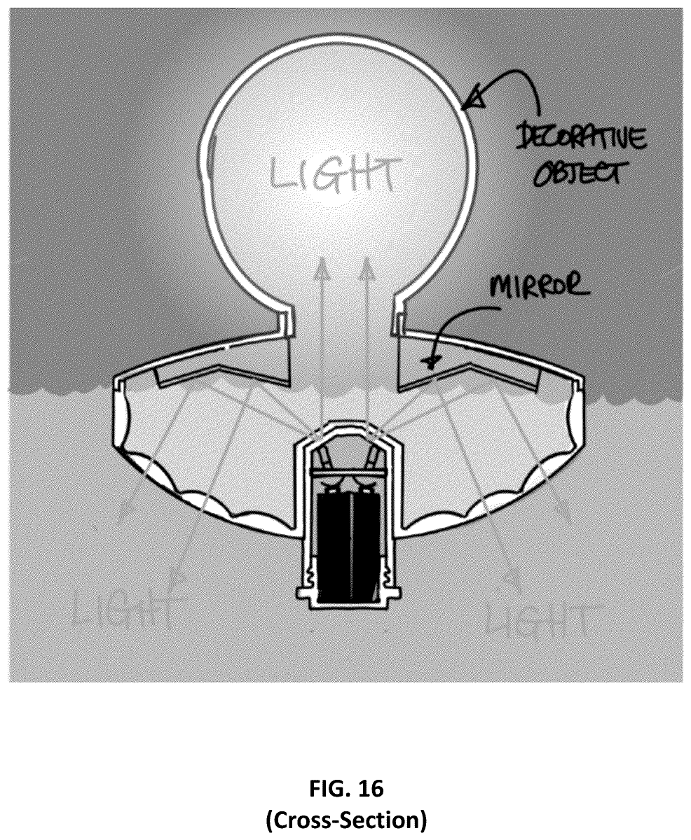

In embodiments, the lid is featureless and merely provides a “top” to the apparatus. Other embodiments of the apparatus include a lid that further includes one or more lenses for focusing and projecting light, a decorative object (which, itself can be configured to be illuminated, see FIG. 16), controls, receivers, or solar panels.

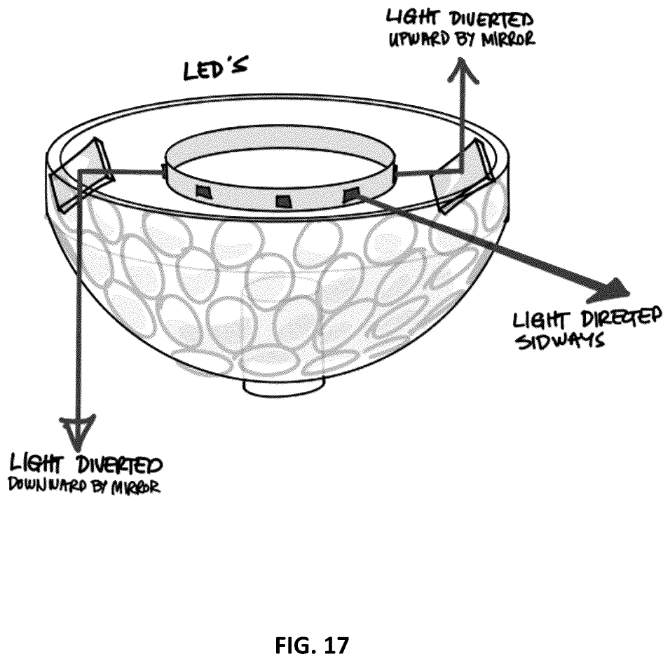

In embodiments, the dome, at a minimum, creates a hollow volume to provide a buoyancy force. In embodiments the dome additionally is configured with one or more lens for focusing and projecting light. Embodiments of the invention include a dome with one or more lens that protrude from the inside surface of the dome, thereby leaving the dome with a smooth exterior surface. See FIGS. 13 and 17.

In embodiments, the light engine provides the light source. In other embodiments, the light engine includes one or more of a light source, a power source, and a control board. in preferred embodiments, the light engine provides the ballast force to counter the buoyancy force.

The location, number, and style of reflector is configured based upon the location and number of light source(s) as well as the location and number of lens(es). In embodiments the reflector is a single continuous surface, such as, but not limited to, a reflective dome, cone, or plane. In other embodiments, the reflector may be a combination of planar facets. In other embodiments, the reflector may be configured as a combination of one or more of a dome, a plane, or a multi-faceted surface.

The housing, comprised here by the lid and the dome, defines an inner chamber, where said inner chamber has an inner chamber volume configured to produce a buoyancy force, and is further adapted to resist the intrusion of the liquid into the inner chamber. In embodiments, the housing—dome and lid—may be manufactured as one unit or, alternatively, as two separate components that are assembled together. The assembly of lid to dome may be accomplished via a permanent method such as, but not limited to, adhesive bonding or sonic welding. Alternatively, the assembly of the lid to the dome may be accomplished by mechanical means, such as, but not limited to, utilizing screws or other fasteners in addition to employing seals, gaskets, or other means of preventing water intrusion.

The light engine, includes a ballast, in communication with the housing and adapted to counteract the buoyancy force such that the relationship between the amount of the first portion relative to the amount of the second portion is a pre-determined value. The mass and position of the ballast relative to the housing determines the stability of the apparatus in the water, as well as, at what level relative to the surface of the water does the apparatus float or sit—how much is below the surface versus how much protrudes above the surface. In embodiments, the ballast, or entire light engine, may be completely enclosed within the housing. In other embodiments, the light engine may be substantially outside of the housing. In yet further embodiments, the light engine may be permanently attached in the apparatus, or it may be selectively removable from the apparatus.

The light engine also includes a power source. In embodiments this power source may be a sealed permanent battery or a replaceable battery. In embodiments, the power source may further include one or more solar cells to generate electrical energy to power the light source(s). In embodiments utilizing a solar cell to power the light engine, the solar cell may preferably be located on the lid in order to be in the most efficient relationship to the position of the sun.

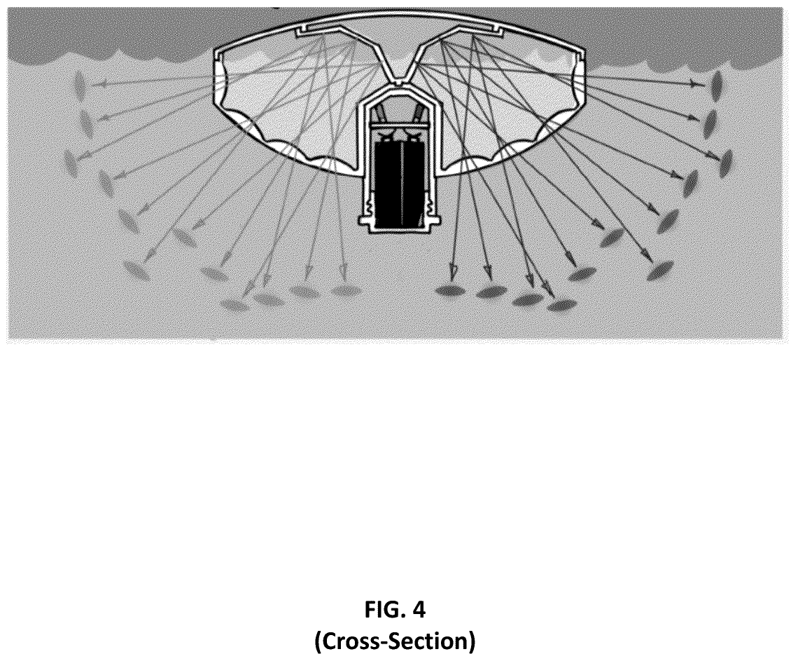

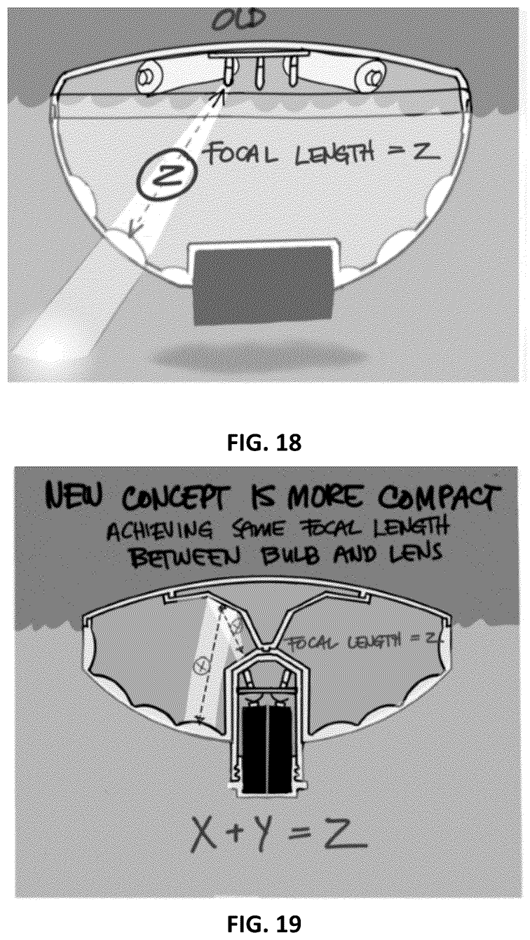

Contained within the housing, a one or more light-reflective surface, reflector 130, is positioned within the inner chamber of the housing and is configured to receive a beam of light from the light source and redirect that beam of light to the dome or lid. In embodiments where the reflector bounces a light beam onto a lens integral to the dome or lid, the reflector provides an improvement over the current state of the art by reducing the size requirement of the dome. For example, in the current state of the art, the dome and housing would be required to have a size capable of accommodating a focal length Z dictated by the straight line distance between the light source and a lens. In the present invention, however, by using specially configured reflector(s) placed between the light source and the lens, the same focal length Z may be achieved in a smaller package by breaking up the line from the light to the lens into smaller segments X and Y where X and Y are not necessarily co-linear, but X+Y=Z. See FIGS. 18-19. Furthermore, the use of one or more reflector can effectively multiply the number of light beams from the light source as well as change directionality and focus of the light beams. See FIGS. 4 and 17.

The light engine further includes a one or more light source, powered by the power source and configured to direct light into the inner chamber onto the one or more light-reflective surface. Many different types of light sources are contemplated to be within the spirit and scope of the present invention. However, preferred embodiments of the present invention utilize light emitting diodes (LEDs) for their compact size, long life, cost, and efficiency.

Preferred embodiments of the apparatus included a one or more lens integral to the housing, the lid or dome, and adapted to be optically transmissive, each of the one or more lens configured to receive light from at least one of the one or more light-reflective surface, said light passing through the lens and projecting outwardly therefrom.

The combination of the light source, reflector(s), and lenses provide a marked improvement over the current state of the art. By combining these elements into one apparatus, not only is a smaller overall package able to be provided, but never before has the light been able to be controlled, focused and directed in such a cost effective and controlled manner.

Whereas, in the current state of the art, a floating pool light can only cast light down onto the pool floor, up out of the pool, or in a diffused omnidirectional manner (albeit all with limitations, shadows, and “dark” spots), the present invention overcomes these issues. As can be seen in the included figures and as disclosed herein, the use, selection, and combination of light+reflector+lens yields a result greater than traditional pool lights alone.

For example, reflectors positioned and configured to direct light from a single source onto multiple lenses disposed in the dome at a desired focal length, will create focused “dots” of light that are projected onto the pool floor and walls.

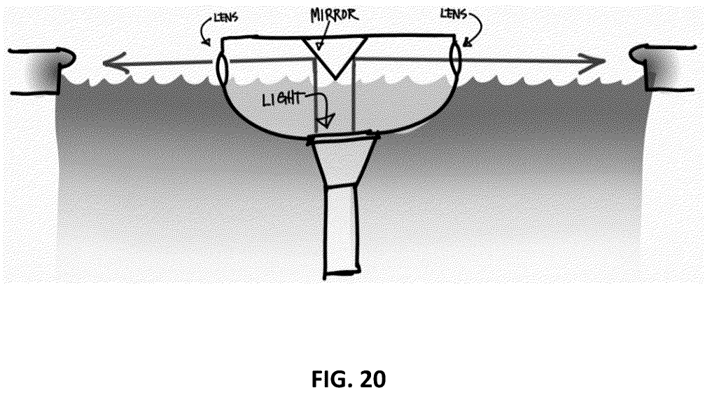

In other embodiments, lenses are included in the housing in a peripheral ring (see FIG. 20). Here the reflectors direct light beams (or the light engine may project the light directly as in FIG. 17) to lenses that project focus patterns of light substantially along the water surface and onto the pool sidewall or coping. Depending on the desired buoyancy of the apparatus, these “horizontal” light beams may project above the water onto the pool side coping, at the water level itself, or below the water level onto the pool sidewall/coping.

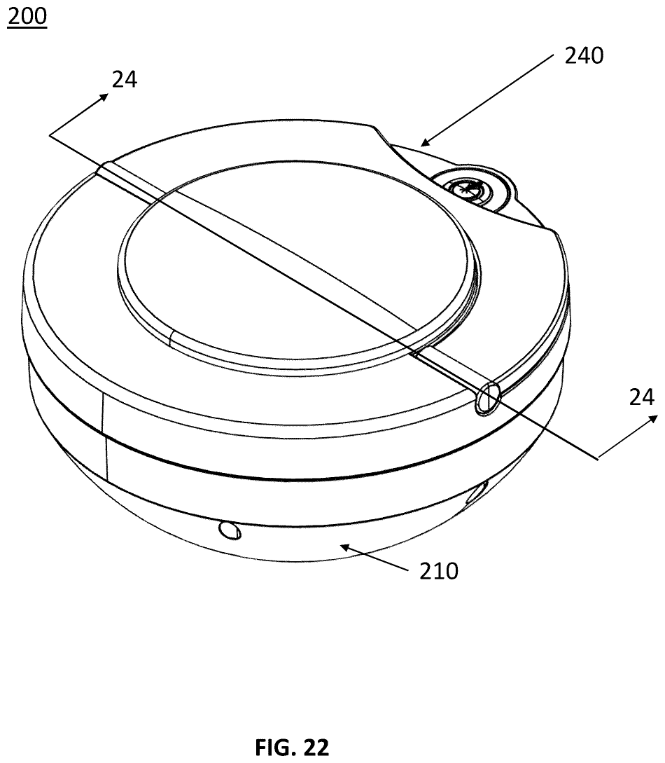

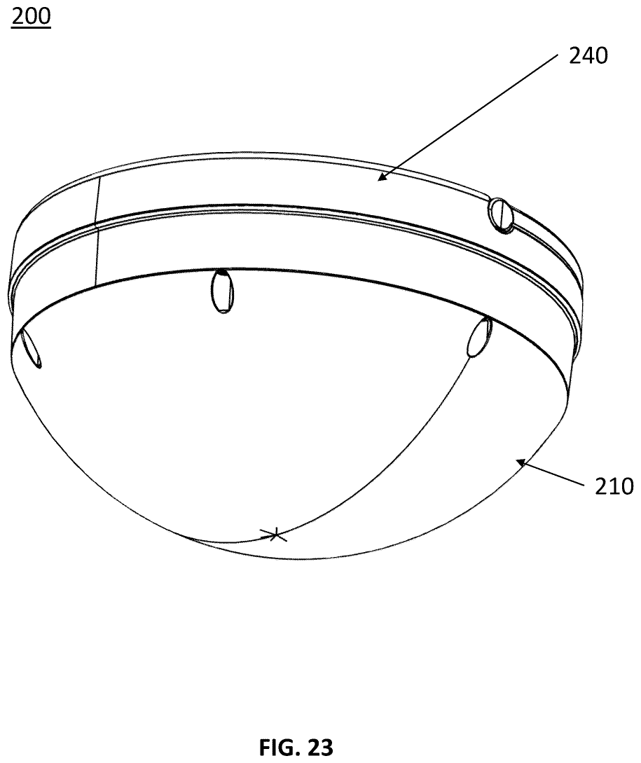

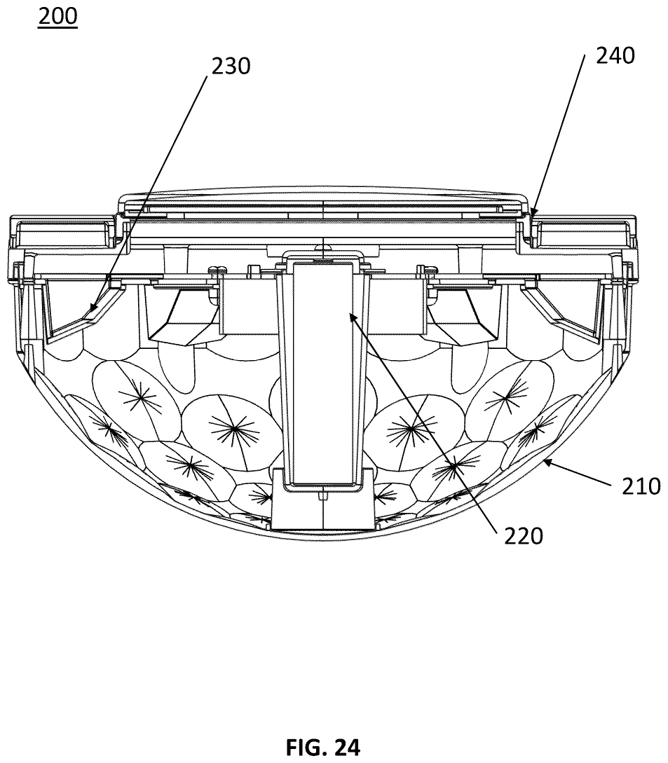

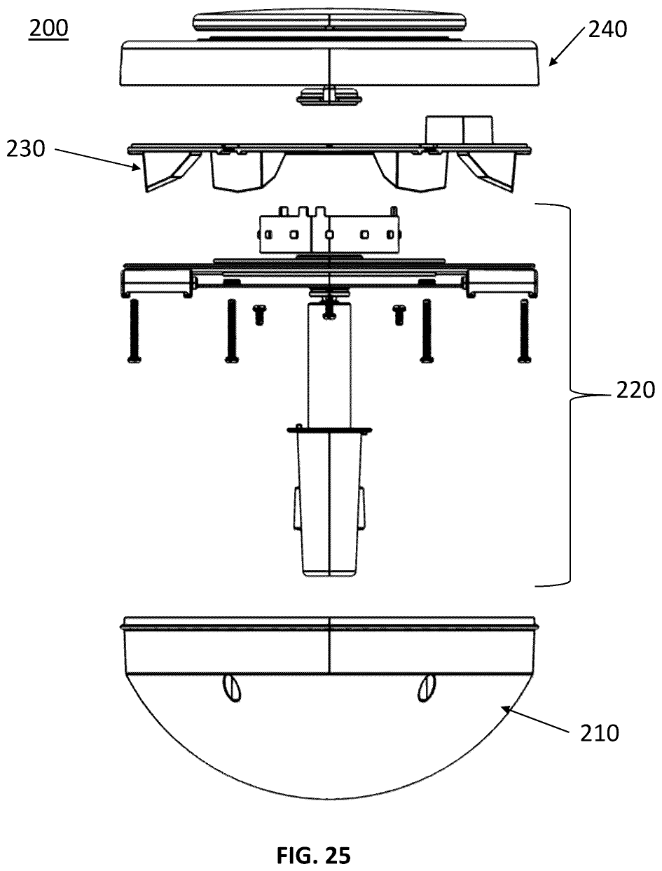

Referring now to FIGS. 22-25, we disclose another exemplary embodiment of a floating pool light according to the present invention. The apparatus 200 includes a housing that includes dome 210 and a lid 240; a one or more reflector 230 within the housing; and, a light engine 220 that includes a ballast, a power source, and a one or more light source.

As mentioned, above, embodiments of the apparatus include a solar panel integral to the lid and in electrical communication with the light engine.

Other embodiments include at least one processor specially programmed to control at least one of the one or more light source.

Other embodiments may include power buttons, controls, infrared, wireless or other receivers to remotely receive control instructions.

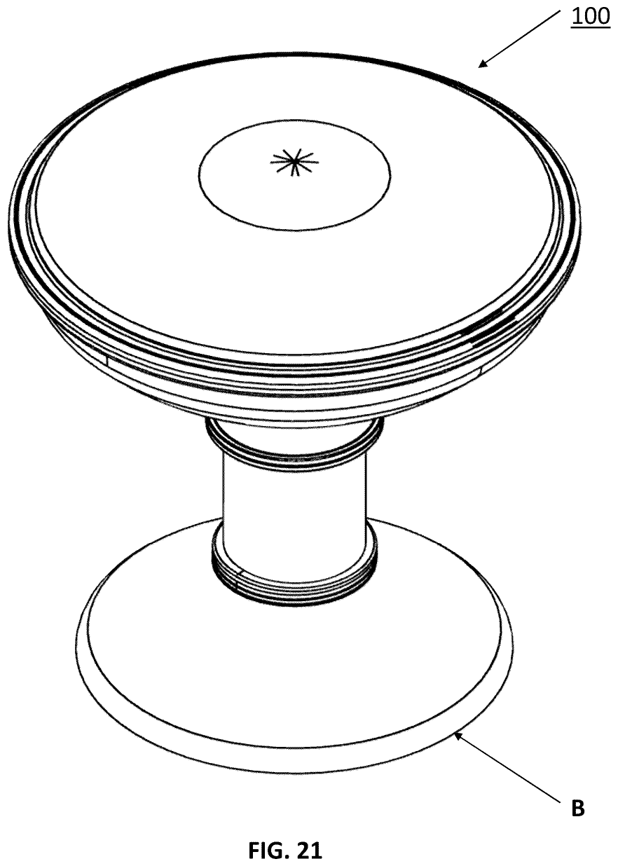

Yet other embodiments include a detachable base B so that the light may be utilized out of the water on any solid surface. (See FIG. 21)

In light of the foregoing description, it should be recognized that embodiments in accordance with the present invention can be realized in numerous configurations contemplated to be within the scope and spirit of the claims. Additionally, the description above is intended by way of example only and is not intended to limit the present invention in any way, except as set forth in the claims.

1. A light apparatus, configured to float buoyantly in a liquid such that a first portion of the light apparatus is above a surface of the liquid and a second portion of the light apparatus is submerged below the surface of the liquid, the light apparatus comprising:
a housing, defining an inner chamber, said inner chamber having an inner chamber volume configured to produce a buoyancy force, and further adapted to resist the intrusion of the liquid into the inner chamber;
a ballast, in communication with the housing and adapted to counteract the buoyancy force such that the relationship between the amount of the first portion relative to the amount of the second portion is a pre-determined value;
a power source;
a one or more light-reflective surface positioned within the inner chamber;
a one or more light source, powered by the power source and configured to direct light into the inner chamber onto the one or more light-reflective surface; and
a one or more lens integral to the housing and adapted to be optically transmissive, each of the one or more lens configured to receive light from at least one of the one or more light-reflective surface, said light passing through the lens and projecting outwardly therefrom.

2. The light apparatus of claim 1, further comprising a one or more lens configured to project light substantially parallel to, and at the level of, a surface of the liquid.

3. The light apparatus of claim 1, further comprising a one or more lens configured to project light substantially below a surface of the liquid.

4. The light apparatus of claim 1, further comprising a one or more lens configured to project light substantially above a surface of the liquid.

5. The light apparatus of claim 1, where the one or more light-reflective surface, the one or more light source, and the one or more lens are configured to project light that is substantially below a surface of the liquid and not obstructed by the ballast.

6. The light apparatus of claim 1, where the ballast includes a light unit.

7. The light apparatus of claim 6, where the light unit comprises: a sealed light unit housing; the power source; and the one or more light source.

8. The light apparatus of claim 6, where the light unit is configured to be adjustable.

9. The light apparatus of claim 6, where the light unit is configured to be detachable.

10. The light apparatus of claim 6, where the light unit is configured to be interchangeable.

11. The light apparatus of claim 1, further comprising a decorative object located on the housing proximate to the upper portion and optically communicative with the inner chamber.

12. The light apparatus of claim 1, further comprising a solar panel located on the housing proximate to the upper portion.

13. The light apparatus of claim 1, further comprising at least one processor specially programmed to control at least one of the one or more light source.

14. A floating pool light apparatus configured to project light horizontally thereby illuminating a pool edge, the apparatus comprising:
an upper portion having a top, a bottom, and a side extending therebetween and creating an inside and an outside, the inside configured to define a center of buoyancy, substantially aligned with a geometric center of the upper portion, and create a buoyancy force;
a lower portion fixedly attached to the bottom of the buoyant upper portion and protruding distally towards the outside from the bottom, the lower portion configured to create a force opposing the buoyancy force and substantially aligned with the center of buoyancy;
a plurality of lenses integral to the side;
a light source integral to the lower portion, configured to project light into the inside of the upper portion;
a reflective surface, attached to the inside of the upper portion distal from the light source and configured to direct light from the light source towards the plurality of lenses; and
a power source, integral to the lower portion and electrically communicative to the light source.

15. The floating pool light of claim 14 further comprising at least one processor, in operative communication with the light source and the power source, specially programmed to control the light source.
